(19) United States
(12) Patent Application Publication
(10) Pub. No.: US 2014/0300999 A1
(43) Pub. Date: Oct. 9, 2014

(54) EXCESS POWER PROTECTION CIRCUIT

(71) Applicants: Hon Hai Precision Industry Co., Ltd., New Taipei (TW); Hong Fu Jin Precision Industry (ShenZhen) Co., Ltd., Shenzhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/243,001

(22) Filed: Apr. 2, 2014

(30) Foreign Application Priority Data
Apr. 9, 2013 (CN) 2013101203615

(51) Int. Cl. H02H 3/26

(52) U.S. Cl. CPC H02H 3/26
USPC 361/18

(57) ABSTRACT

A protection circuit against excess power includes a power supply, a converter, a voltage divider, a comparison module, and a switch. The converter converts a first input voltage from the power supply into a first output voltage. The voltage divider divides the first output voltage into a first divided voltage. Using negative-coefficient thermistors as resistances, the first divided voltage increases when a temperature around the voltage divider increases. The comparison module compares the first divided voltage to a preset voltage and outputs a first or a second signal corresponding to the result of the comparison. The switch allows the power supply to continue operating or to shut down according to the first or to the second signal.

### FIELD

The present disclosure relates to a power protection circuit.

### BACKGROUND

When a power supply of a motherboard operates abnormally, the current being output from the power supply may exceed normal parameters, increasing a temperature of the motherboard. If the power supply is not shut down quickly, the motherboard will be damaged.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. In the drawing(s), like reference numerals designate corresponding parts throughout the several views.

FIG. 1 is a block diagram of an embodiment of an excess power protection circuit of the present disclosure.

FIG. 2 is a circuit diagram of the excess power protection circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The reference “a plurality of” means “at least two.”

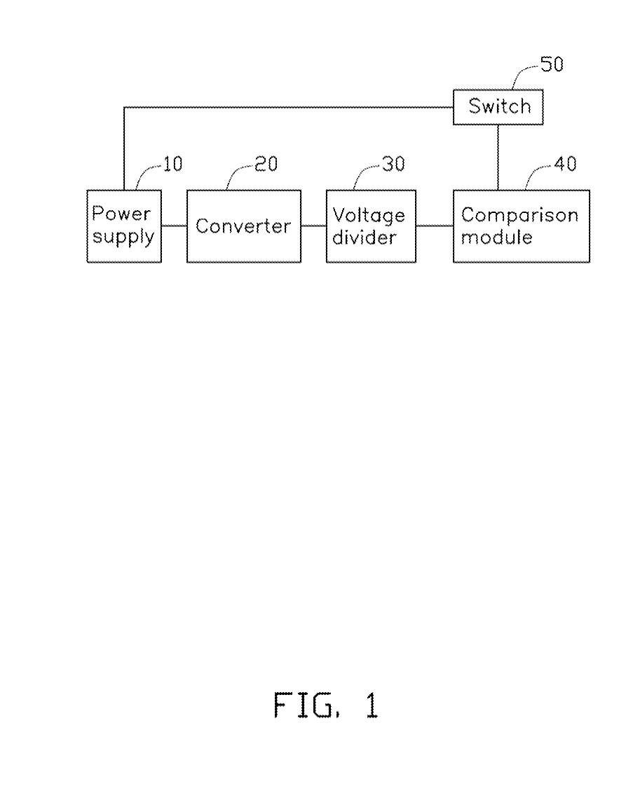

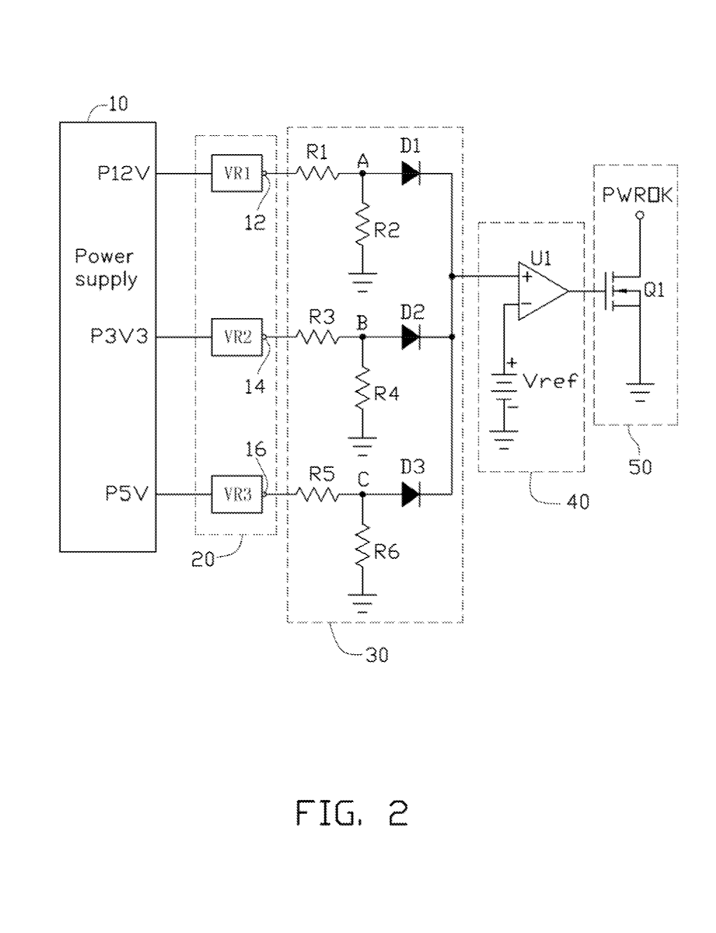

FIGS. 1 and 2 show an embodiment of a power protection circuit 100 of the present disclosure.

The power protection circuit 100 comprises a power supply 10, a converter 20, a voltage divider 30, a comparison module 40, and a switch 50.

The converter 20 is connected to the power supply 10. The converter 20 is used to convert a voltage from the power supply 10 and output a converted voltage. The converter 20 comprises three converting units VR1, VR2, and VR3. The converting units VR1, VR2, and VR3 are connected to first through third output terminals, P12V, P3V3, and P5V of the power supply 10 respectively. The converting unit VR1 converts a first voltage from the first output terminal P12V into a voltage Vout1 and outputs the voltage Vout1. The converting unit VR2 converts a second voltage from the second output terminal P3V3 into a voltage Vout2 and outputs the voltage Vout2. The converting unit VR3 converts a third voltage from the third output terminal P5V into a voltage Vout3 and outputs the voltage Vout3.

The voltage divider 30 comprises first through sixth resistors R1-R6 and first through third diodes D1-D3. An output 12 of the converting unit VR1 is grounded through the first resistor R1 and the second resistor R2 in that order. A node A between the first and second resistors R1 and R2 is connected to an anode of the first diode Dl. An output 14 of the converting unit VR2 is grounded through the third resistor R3 and the fourth resistor R4 in that order. A node B between the third and fourth resistors R3 and R4 is connected to an anode of the second diode D2. An output 16 of the converting unit VR3 is grounded through the fifth and sixth resistors R5 and R6 in that order. A node C between the fifth and sixth resistors R5 and R6 is connected to an anode of the diode D3.

In the embodiment, Values of Vout1, Vout2, and Vout3 are the same. The first resistor R1, the third resistor R3, and the fifth resistor R5 are negative temperature coefficient thermistors. Resistances of the negative temperature coefficient thermistors increase when a temperature falls.

The comparison module 40 comprises an operational amplifier U1. The switch 50 comprises an n-channel metal-oxide-semiconductor field effect transistor (MOSFET) Q1. A positive electrode of a power source Vref is connected to an inverting input of the operational amplifier U1. A negative electrode of the power source Vref is grounded. Cathodes of the first through third diodes D1-D3 are connected to a non-inverting input of the operational amplifier U1. An output of the operational amplifier U1 is connected to a gate of the MOSFET Q1. A source of the MOSFET Q1 is grounded. A drain of the MOSFET Q1 is connected to an input terminal PWROK of the power supply 10. The power source Vref outputs a voltage Vmax. When the converter 20 operates normally, a temperature of the voltage divider 30 is in a normal range, thus the temperature is not greater than a preset value, the voltage Vout of the non-inverting input of the operational amplifier U1 is not greater than the voltage Vmax at the inverting input of the operational amplifier U1. The operational amplifier U1 outputs a low level signal, such as logic 0. Thus, MOSFET Q1 is turned off When the converter 20 operates abnormally, the temperature is increased and is greater than the preset value, and the voltage Vout becomes greater than the voltage Vmax. The operational amplifier U1 then outputs a high level signal, such as logic 1. The MOSFET Q1 is turned on. The input terminal PWROK of the power supply 10 is grounded and the power supply 10 is shut off. The power protection circuit 100 stops an operation of the power supply 10 when the temperature is greater than the preset value to protect the power supply 10.

While the disclosure has been described by way of example and in terms of preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power protection circuit, comprising:
a power supply to provide a first input voltage;
a first converter to convert the first input voltage from the power supply into a first output voltage;
a voltage divider configured to divide the first output voltage and output a first divided voltage, wherein the first divided voltage increases when a temperature around the voltage divider increases;
a comparison module configured to compare the first divided voltage with a preset voltage, wherein when the temperature around the voltage divider is lower than a preset value, the first divided voltage is less than the preset voltage and the comparison module outputs a first signal; when the temperature around the voltage divider is equal to the preset value, the first divided voltage is equal to the preset voltage and the comparison module outputs the first signal; and when the temperature around the voltage divider is higher than the preset value, the first divided voltage is greater than the preset voltage and the comparison module outputs a second signal; and
a switch connected to the comparison module to control operation of the power supply, wherein when the comparison module outputs the first signal to the switch, the switch enables operation of the power supply, when the comparison module outputs the second signal to the switch, the switch stops operation of the power supply.

2. The power protection circuit of claim 1, wherein:
the voltage divider comprises a first resistor, a second resistor, and a first diode; an output of the first converter is grounded through the first and second resistors in that order, an anode of the first diode is connected to a node between the first and second resistors, and a cathode of the first diode is connected to the comparison module.

3. The power protection circuit of claim 2, wherein the converter comprises a second converter and a third converter, and the second and third converters convert second and third input voltages from the power supply into second and third output voltages respectively.

4. The power protection circuit of claim 3, wherein the voltage divider further comprises a third resistor, a fourth resistor, a fifth resistor, a sixth resistor, a second diode, and a third diode, each of the second and third converters has an output, the output of the second converter is grounded through the third and fourth resistors in that order, an anode of the second diode is connected to a node between the third and fourth resistors, the output of the third converting unit is grounded through the fifth and sixth resistors in that order, an anode of the third diode is connected to a node between the fifth resistor and the sixth resistor, and cathodes of the second and third diodes are connected to the comparison module.

5. The power protection circuit of claim 4, wherein the first resistor, the third resistor, and the fifth resistor are negative temperature coefficient thermistors.

6. The power protection circuit of claim 1, wherein the preset voltage is provided by a power source, a positive electrode of the power source is connected to the comparison module, and a negative electrode of the power source is grounded.

7. The power protection circuit of claim 5, wherein the comparison comprises an operational amplifier, a non-inverting input of the operational amplifier is connected to cathodes of the first to third diodes, and an inverting input of the operational amplifier receives the preset voltage, and an output of the operational amplifier is connected to the switch.

8. The power protection circuit of claim 6, wherein the switch is an n-channel metal-oxide-semiconductor field effect transistor (MOSFET), a gate of the MOSFET is connected to the output of the operational amplifier, a source of the MOSFET is grounded, and a drain of the MOSFET is connected to a control terminal of the power supply.
